(19) United States
(12) Patent Application Publication
(10) Pub. No.: US 2024/0174907 A1
(43) Pub. Date: May 30, 2024

(54) CURABLE POLYOLEFIN COMPOSITION AND CURED PRODUCT

(71) Applicants: DOW GLOBAL TECHNOLOGIES LLC, Midland, MI (US); DOW SILICONES CORPORATION, Midland, MI (US)

(72) Inventors: Chao HE, Shanghai (CN); Dorab BHAGWAGAR, Auburn, MI (US); Ling LING, Shanghai (CN); Hongyu CHEN, Shanghai (CN); Chen CHEN, Shanghai (CN); Jiguang ZHANG, Shanghai (CN)

(21) Appl. No.: 18/283,319

(22) PCT Filed: Mar. 30, 2021
(86) PCT No.: PCT/CN2021/083942

§ 371 Date: Sep. 21, 2023

(51) Int. Cl. C09K 5/14; C08G 77/442; C08K 9/06; H01M 10/625; H01M 10/653

(52) U.S. Cl. CPC C09K 5/14; C08G 77/442; C08K 9/06; H01M 10/625; H01M 10/653; C08K 2201/001; H01M 2220/20

(57) ABSTRACT

A curable polyolefin composition is provided. The curable polyolefin composition comprises: (A) a polyolefin having at least two aliphatic unsaturated bonds per molecule and having a viscosity at 25° C. of less than 2,500 mPa·s; (B) an organopolysiloxane having at least two silicon atom-bonded hydrogen atoms per molecule; (C) a hydrosilylation reaction catalyst; and (D) a thermal conductive filler. The curable polyolefin composition can be cured to form a soft material with good thermal conductive properties.

### TECHNICAL FIELD

The present invention relates to a curable polyolefin composition and a cured product thereof.

### BACKGROUND ART

Thermal gap fillers are commonly used in Transportation Assembly for thermal management of batteries in Electric Vehicles. Batteries have optimal performance between 15 and 35° C. High temperature degrades batteries, reducing lifetime. Safety is also compromised with high temperatures potentially leading to catastrophic runaway reactions. The electrochemical reactions in batteries produce heat and this heat must be removed by using a thermal gel as a gap filler between the battery and the heat sink.

There is a strong business interest for silicone-free or reduced silicone polymer matrix based gap fillers. Volatile silicone species can condense in un-wanted areas in Original Equipment Manufacturers (OEMs) manufacturing plants. This can cause many issues related to paint-ability of the automotive and occurrence of paint defects such as “fish-eye.”

Patent Document 1 describes a rubber composition comprising: a polyisobutylene polymer having an allyl radical at an end, an organohydrogenpolysiloxane having at least two silicon atom-bonded hydrogen atoms per molecule; and a platinum group metal catalyst, wherein the composition forms a seal member on a periphery of one side of a polymer electrolyte fuel-cell separator.

Patent Document 2 describes a rubber compound comprising: a rubber which has at least two functional groups which can be cross-linked by hydrosilylation, a cross-linking agent consisting of hydrosiloxane or a hydrosiloxane derivative or a mixture of several hydrosiloxanes or derivatives, which comprise at least two silicon atom-bonded hydrogen groups per molecule, a hydrosilylation catalyst, at least one filler; and a coagent which can be cross-linked by hydrosilylation.

Patent Document 3 describes a hydrosilylation curable composition comprising: an organic polymer having on average at least 1.4 alkenyl groups per molecule, a crosslinker having on average at least 1.4 silicon atom-bonded hydrogen atoms per molecule, a platinum group metal-containing catalyst, an alkoxy silyl substituted organic oligomer having a number average molecular weight in the range of 200 to 5,000, having a polymer backbone selected from the group of polybutadiene, polyisoprene, polyisobutylene, copolymers of isobutylene and isoprene, copolymers of isoprene and butadiene, copolymers of isoprene and styrene, copolymers of butadiene and styrene, copolymers of isoprene, butadiene and styrene and polyolefin polymers prepared by hydrogenating polyisoprene, polybutadiene or a copolymer of isoprene and styrene, a copolymer of butadiene and styrene or a copolymer of isoprene, butadiene and styrene.

Patent Document 4 describes a polyolefin rubber composition comprising: an ethylene/α-olefin/nonconjugated polyene random copolymer, an organopolysiloxane containing on average from 1 to less than 2 silicon atom-bonded hydrogen atoms in a molecule, and an addition reaction catalyst, wherein the composition can be compression molded or steam vulcanized into a cured product having heat resistance and surface lubricity.

However, these are silent about a soft material with good thermal conductive properties.

### PRIOR ART DOCUMENTS

### Patent Documents

Patent Document 1: U.S. Patent Application Publication No. 2003/0045615 A1
Patent Document 2: U.S. Patent Application Publication No. 2008/0315148 A1
Patent Document 3: U.S. Patent Application Publication No. 2010/0206477 A1
Patent Document 4: U.S. Patent Application Publication No. 2014/0200297 A1

### SUMMARY OF INVENTION

### Technical Problem

An object of the present invention is to provide a curable polyolefin composition that can be cured to form a soft material with good thermal conductive properties. An object of the present invention is to provide a cured product in the form of soft material with good thermal conductive properties.

### Solution to Problem

The curable polyolefin composition of the present invention comprises:
(A) a polyolefin having at least two aliphatic unsaturated bonds per molecule and having a viscosity at 25° C. of less than 2,500 mPa·s;
(B) an organopolysiloxane having at least two silicon atom-bonded hydrogen atoms per molecule, in an amount such that a cured product obtained by curing the present composition has a Shore OO hardness of less than 80;
(C) a hydrosilylation reaction catalyst, in an amount such that a catalytic metal in this component relative to the present composition is not less than 2 ppm in terms of mass unit; and
(D) a thermal conductive filler.

In various embodiments, component (A) is a polybutadiene.

In various embodiments, component (D) is a thermal conductive filler selected from metals, alloys, nonmetals, metal oxides, metal hydroxides or ceramics.

In various embodiments, a content of component (D) is not less than 50 mass % of the present composition.

In various embodiments, the curable polyolefin composition further comprises: (E) a filler treating agent.

In various embodiments, a content of component (E) is not more than 1 mass % of the present composition.

The cured product of the present invention is obtained by curing the curable polyolefin composition described above, wherein the cured product has a Shore OO hardness of less than 80.

In various embodiment, the cured product is characterized by being used between a battery and a heat sink in an electric vehicle.

### Effects of Invention

The curable polyolefin composition of the present invention can be cured to form a soft material with good thermal conductive properties. And the cured product of the present invention is in the form of a soft material with good thermal conductive properties.

### Definitions

The terms “comprising” or “comprise” are used herein in their broadest sense to mean and encompass the notions of “including,” “include,” “consist(ing) essentially of,” and “consist(ing) of.” The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

The term “soft material” is used herein to mean a material like a gel, which has a Shore OO hardness of less than 80 or Shore A hardness of less than 25 in accordance with ASTM D 2240.

### DETAILED DESCRIPTION OF THE INVENTION

The curable polyolefin composition of the present invention will be explained in detail.

Component (A) is a main component and a polyolefin having at least two aliphatic unsaturated bonds per molecule. Here, component (A) is a polyolefin grafting on the main chain groups with aliphatic unsaturated bond, or a polyolefin having a main chain including aliphatic carbon-carbon unsaturated bonds. Component (A) may be linear or branched and may be a homopolymer, copolymer or terpolymer. Component (A) may also be present as a mixture of different polyolefins so long as there is on average at least two aliphatic unsaturated bonds per molecule. Examples of the polyolefin for component (A) include a polyisoprene, a polybutadiene, a copolymer of ethylene, propylene, isobutylene and isoprene, a copolymer of isoprene and butadiene, a copolymer of isoprene and styrene, a copolymer of butadiene and styrene, a copolymer of isoprene, butadiene and styrene and a polyolefin polymer prepared by hydrogenating polyisoprene, polybutadiene or a copolymer of isoprene and styrene, a copolymer of butadiene and styrene or a copolymer of isoprene, butadiene and styrene. Among them, component (A) is preferably a polybutadiene.

The aliphatic unsaturated bonds in a molecule of component (A) may be the same or different and may comprises 2 or more carbon atoms, but preferably comprise between 2 and 12 carbon atoms. They may be linear or branched but linear alkenyl groups are preferred. Examples of suitable groups with aliphatic unsaturated bond include alkenyl groups such as vinyl groups, allyl groups, butenyl groups, pentenyl groups, and hexenyl groups, and vinyl and/or allyl groups are particularly preferred. The groups with aliphatic unsaturated bond may be found pendant along the polymer chain or at the chain ends, with it being preferable for the groups to be at the chain ends.

Component (A) has a viscosity at 25° C. of less than 2,500 mPa·s, preferably in a range of from 1 to 2,000 mPa·s, alternatively in a range of from 1 to 1,500 mPa·s, or alternatively in a range of from 1 to 1,000 mPa·s. Note that in the present specification, viscosity may be measured in accordance with JIS K7117-1: Plastics—Resins in the liquid state or as emulsions or dispersions—Determination of apparent viscosity by the Brookfield Test method, or ISO 2555: Plastics Resins in the Liquid State or as Emulsions or Dispersions Determination of Apparent Viscosity by the Brookfield Teste Method.

An exemplary commercially available polyolefin is liquid polybutadienes Ricon® 130, 156 and 257; Poly bd R-20LM, available from CRAY VALLEY.

The content of component (A) is not limited, but it is preferably in a range of from 5 to 30 mass %, alternatively in a range of from 8 to 20 mass %, or alternatively in a range of from 9 to 16 mass %, of the present composition. This is because when the content of component (A) is equal to or greater than the lower limit of the range described above, curability of the present composition is good, whereas when the content of component (A) is equal to or less than the upper limit of the range described above, thermal conductive properties of the cured product are good.

Component (B) is an organopolysiloxane having at least two silicon atom-bonded hydrogen atoms per molecule. Organic groups in the organopolysiloxanes for component (B) are exemplified by monovalent hydrocarbon groups free of aliphatic unsaturated bonds, such as methyl groups, ethyl groups, propyl groups, butyl groups, pentyl groups, hexyl groups, heptyl groups, and other alkyl groups having 1 to 12 carbon atoms; phenyl groups, tolyl groups, xylyl groups, naphthyl group, and other aryl groups having 6 to 12 carbon atoms, and methyl groups and phenyl groups are most typical.

The organopolysiloxanes for component (B) are exemplified by methylphenylpolysiloxane having both terminals of the molecular chain end-blocked by dimethylhydrogensiloxy groups; methylphenylsiloxane-dimethylsiloxane copolymer having both terminals of the molecular chain end-blocked by dimethylhydrogensiloxy groups; methylphenylsiloxane-methylhydrogensiloxane copolymer having both terminals of the molecular chain end-blocked by trimethylsiloxy groups; methylphenylsiloxane-methylhydrogensiloxane-dimethylsiloxane copolymer having both terminals of the molecular chain end-blocked by trimethylsiloxy groups; organopolysiloxane copolymer made up of siloxane units represented by (CH₃)₂HSiO_{1/2} and siloxane units represented by C₆H₅SiO_{3/2}; organopolysiloxane copolymer made up of siloxane units represented by (CH₃)₂HSiO_{1/2}, siloxane units represented by (CH₃)₃SiO_{1/2}, and siloxane units represented by C₆H₅SiO_{3/2}; organopolysiloxane copolymer made up of siloxane units represented by (CH₃)₂HSiO_{1/2}, siloxane units represented by (CH₃)₂SiO_{2/2}, and siloxane units represented by C₆H₅SiO_{3/2}; organopolysiloxane copolymer made up of siloxane units represented by (CH₃)₂HSiO_{1/2}, siloxane units represented by C₆H₅(CH₃)₂SiO_{1/2}, and siloxane units represented by SiO_{4/2}; organopolysiloxane copolymer made up of siloxane units represented by (CH₃)HSiO_{2/2} and siloxane units represented by C₆H₅SiO_{3/2}; as well as mixtures of two or more of the above. It is advantageous to have component (B) exhibit some compatibility with component (A). Without being bound by theory it is assumed that incompatibility between components (A) and (B) will drive component separation and provide cured product with poor physical properties. Incompatibility can be judged visually by opacity or phase separation of component (A) and (B).

The content of component (B) is in an amount such that a cured product obtained by curing the present composition has a Shore OO hardness of less than 80. However, when component (B) is an organopolysiloxane having two silicon atom-bonded hydrogen atoms in a molecule, it acts as a chain extender, so the content of component (B) is preferably in an amount such that silicon atom-bonded hydrogen atoms is preferably in a range of from 1 to 5 mass %, alternatively in a range of from 1.5 to 4.5 mass %, or alternatively in a range of from 1.5 to 4 mass %, each based on a total mass of components (A) to (C) of the present composition. When component (B) is an organopolysiloxane having at least three silicon atom-bonded hydrogen atoms in a molecule wherein each silicon atom-bonded hydrogen atoms bond to terminal of the molecular chain, it acts as a crosslinking agent, so the content of component (B) is preferably in an amount such that silicon atom-bonded hydrogen atoms is preferably in a range of from 1 to 5.5 mass %, alternatively in a range of from 3 to 5.5 mass %, or alternatively in a range of from 4 to 5.5 mass %, each based on a total mass of components (A) to (C) of the present composition. Furthermore, when component (B) is an organopolysiloxane having at least three silicon atom-bonded hydrogen atoms in a molecule wherein each silicon atom-bonded hydrogen atoms bond to side chain of the molecular chain, it acts as a crosslinking agent, however, its activity is low, so the content of component (B) is preferably in an amount such that silicon atom-bonded hydrogen atoms is preferably in a range of from 1 to 10 mass %, alternatively in a range of from 1 to 9 mass %, or alternatively in a range of from 1 to 8 mass %, each based on a total mass of components (A) to (C) of the present composition. These are because the composition can be satisfactorily cured if the content of component (B) is not less than the lower limit of the above-mentioned range, and the soft material is obtained if the content of component (B) is not more than the upper limit of the above-mentioned range.

Component (C) is a hydrosilylation reaction catalyst used to facilitate curing of the present composition. Examples of component (C) include platinum-based catalysts, rhodium-based catalysts, and palladium-based catalysts. Component (C) is typically a platinum-based catalyst so that the curing of the present composition can be dramatically accelerated. Examples of the platinum-based catalyst include a platinum fine powder, chloroplatinic acid, an alcohol solution of chloroplatinic acid, a platinum-alkenylsiloxane complex, a platinum-olefin complex and a platinum-carbonyl complex, with a platinum-alkenylsiloxane complex being most typical.

The content of component (C) in the present composition is in an amount such that a catalytic metal in this component relative to the present composition is not less than 2 ppm, preferably in a range of from 2 to 500 ppm, alternatively from 2 to 100 ppm, or alternatively from 2 to 50 ppm, in terms of mass unit. This is because the composition can be satisfactorily cured if the content of component (C) is not less than the lower limit of the above-mentioned range, and the heat resistance of the cured product is improved if the content of component (C) is not more than the upper limit of the above-mentioned range.

Component (D) is at least one thermally conductive filler. For instance, component (D) can be any one or any combination of more than one thermally conductive filler selected from metals, alloys, nonmetals, metal oxides, metal hydrates or ceramics. Exemplary metals include but are not limited to aluminum, copper, silver, zinc, nickel, tin, indium, and lead. Exemplary nonmetals include but are not limited to carbon, graphite, carbon nanotubes, carbon fibers, graphenes, and silicon nitride. Exemplary metal oxides, metal hydroxides and ceramics include but are not limited to alumina, aluminum hydroxide, aluminum nitride, boron nitride, zinc oxide, and tin oxide. Desirably, component (D) is any one or any combination of more than one selected from a group consisting of alumina, aluminum, zinc oxide, boron nitride, aluminum nitride, and aluminum oxide trihydrate. Even more desirably, component (D) is any one or any combination or more than one filler selected from aluminum oxide particles having an average size of less than 5 μm, aluminum oxide particles having an average particle size of 5 μm or more, aluminum hydroxide particles having an average size of less than 5 μm, aluminum hydroxide particles having an average particle size of 5 μm or more. Determine average particle size for filler particles as the median particle size (D50) using laser diffraction particle size analyzers (CILAS920 Particle Size Analyzer or Beckman Coulter LS 13 320 SW) according to an operation software.

The amount of component (D) is not limited, but it is preferably not less than 50 mass %, preferably in a range of from 70 to 95 mass %, alternatively in a range of from 75 to 90 mass %, alternatively in a range of from 80 to 90 mass %, of the present composition. This is because when the content of component (D) is equal to or less than the upper limit of the range described above, thermal conductive properties of the cured product are good.

The present composition may further comprise (E) a filler treating agent to assist dispersing of component (D) in component (A). Component (E) is not limited, but it is preferably a silicon-based coupling agent, a titanium-based coupling agent, or an aluminum-based coupling agent.

The silicon-based coupling agent is preferably an alkoxysilane compound represented by the following general formula:

R¹ₐR²_{b}Si(OR³)_{(4-a-b)}

In the formula, R¹ is independently an alkyl group with 6 to 15 carbons. Exemplary alkyl groups include hexyl groups, heptyl groups, octyl groups, nonyl groups, decyl groups, undecyl groups, and dodecyl groups.

In the formula, R² is independently an alkyl group with 1 to 5 carbons or an alkenyl groups with 2 to 6 carbons. Exemplary alkyl groups include methyl groups, ethyl groups, propyl groups, isopropyl groups, butyl groups, isobutyl groups, tert-butyl groups, pentyl groups, and neopentyl groups. Exemplary alkenyl groups include vinyl group, ally group, butenyl groups, pentenyl groups and hexenyl groups.

In the formula, R³ is independently an alkyl group with 1 to 4 carbons. Exemplary alkyl groups include methyl groups, ethyl groups, propyl groups, isopropyl groups, butyl groups, isobutyl groups, and tert-butyl groups.

In the formula, “a” is an integer of 1 to 3, “b” is an integer of 0 to 2, provided that “a+b” is an integer of 1 to 3, alternatively “a” is 1, “b” is an integer of 0 or 1, or alternatively “a” is 1, “b” is 0.

Exemplary silicon-based coupling agents for component (E) include hexyl trimethoxysilane, heptyl trimethoxysilane, octyl triethoxysilane, decyl trimethoxysilane, dodecyl trimethoxysilane, dodecyl methyl dimethoxysilane, dodecyl triethoxysilane, tetradecyl trimethoxysilane, octadecyl trimethoxysilane, octadecyl methyl dimethoxysilane, octadecyl triethoxysilane, nonadecyl trimethoxysilane, and any combination of at least two thereof.

Exemplary titanium-based coupling agents for component (E) include isopropyltriisostearoyl titanate, isopropyltris(dioctylpyrophosphate) titanate, isopropyltri(N-amidoethyl, aminoethyl) titanate, tetraoctylbis(ditridecylphosphate) titanate, tetra(2,2-diallyloxymethyl-1-butyl) bis(ditridecyl)phosphate titanate, bis(dioctylpyrophosphate)oxyacetate titanate, bis(dioctylpyrophosphate)ethylene titanate, isopropyltrioctanoyl titanate, isopropyidimethacrylisostearoyl titanate, isopropyltridodecylbenzenesulfonyl titanate, isopropylisostearoyidiacryl titanate, isopropyltri(dioctylphosphate) titanate, isopropyltricumylphenyl titanate, and tetraisopropylbis(dioctylphosphite) titanate.

Exemplary aluminum-based coupling agents for component (E) include alkylacetoacetate aluminum di-isopropylate.

The amount of component (E) is not limited, but it is preferably 1 mass % or less, alternatively in a range of from 0.01 to 1 mass %, or alternatively in a range of from 0.1 to 1 mass %, of the present composition. This is because when the content of component (E) is equal to or greater than the lower limit of the range described above, dispersing of component (D) in the present composition is good, whereas when the content of component (E) is equal to or less than the upper limit of the range described above, stability of the present composition is good.

The present composition may further comprise additional components such as one or more additives. Such additives include, but are not limited to, antistatic agents, color enhancers, dyes, lubricants, fillers such as TiO₂ or CaCO₃, opacifiers, nucleators, pigments, processing aids, UV stabilizers, anti-blocks, slip agents, tackifiers, fire retardants, anti-microbial agents, odor reducer agents, anti-fungal agents, and combinations thereof.

The present composition can be prepared by combining all of ingredients at ambient temperature. Any of the mixing techniques and devices described in the prior art can be used for this purpose. The particular device used will be determined by the viscosity of the ingredients and the final composition. Cooling of the ingredients during mixing may be desirable to avoid premature curing.

Furthermore, to enhance storage stability, the present composition is preferably a two-component type curable polyolefin composition formed from a Part A containing component (A), component (C), and component (D), but containing no component (B), and a Part B containing component (A), component (B), and component (D), but containing no component (C). Note that component (E) and other additional components may be contained in one or both of the Part A and the Part B.

The viscosity at 25° C. of the present composition is not limited; however, when the present composition is separated into Part A and Part B, each viscosity of Part A and Part B is preferably not more than 300 Pa·s. This is because, when the viscosity of each Part A and Part B is less than or equal to 300 Pa·s, excellent workability of the resulting composition is achieved. Each viscosity is measured on rotational rheometer ARES-G2, shear is 10 (1/s), with the plate diameter of 25 mm and gap of 0.6 mm.

The cured product of the present invention will be explained in detail.

The cured product of the present invention is obtained by curing the curable polyolefin composition described above. The present cured product has a Shore OO hardness of less than 80.

The thermal conductivity of the present cured product is not limited, but it is preferably 1 W/mK or more, alternatively 1.5 W/mK or more, or alternatively 2 W/mK or more.

The present cured product is applied to various uses. In especially, it is preferably used as a thermal conductive material between a battery and a heat sink in an electric vehicle.

### EXAMPLES

The curable polyolefin composition and the cured product of the present invention will be described in detail hereinafter using Practical Examples and Comparative Examples. However, the present invention is not limited by the description of the below listed Practical Examples.

### <Viscosity of Each Part a and Part B for Curable Polyolefin Compositions>

Viscosity of each Part A and part B for curable polyolefin compositions was measured by a rotational rheometer ARES-G2, wherein shear is 10 (1/s), with the plate diameter of 25 mm and gap of 0.6 mm.

### <Hardness of Cured Products>

Each curable polyolefin compositions was poured in aluminum pan and left for 24 hrs. at a room temperature. After curing, each cured products was checked by Shore 00 durometer and Shore A durometer in accordance with ASTM D 2240.

### <Thermal Conductivity (TC) of Cured Products>

Thermal conductivity of cure product was measured by ISO 22007-2:2015 (Test Method for Determining Thermal Conductivity) using Hotdisk transient technology sensor C5501 (Hot Disk AB, Göteborg, Sweden), heat time and power of 5 s/100 mW. Cured product after curing was filled into two cups and put the planar sensor between the cured products. Use fine-tuned analysis with temperature drift compensation and time correction selected between points 10-190.

### Practical Examples 1-9 and Comparative Examples 1-8

Curable polyolefin compositions shown in Table 1 were prepared using the components mentioned below. Firstly, components (A), (D) and (E) were mixed at room temperature homogeneously. And then, components (B) and (C) were added respectively to Part A and Part B of the mixtures. The Part A and Part B were mixed in 1:1 ratio in speed mixer for 1000 rpm for 20 seconds. The final compounding was used as curable polyolefin composition for testing.

The following component was used as component (A).

Component (a-1): a liquid polybutadiene (trade name: Ricon® 130, commercially available from TOTAL CRAY VALLEY; viscosity at 25° C.=750 mPa·s; Mn=2,500; 1,2-vinyl content=28%)

The following component was used as a polyolefin for comparison component (A).

Component (a-2): a liquid polybutadiene (trade name: Ricon® 131, commercially available from TOTAL CRAY VALLEY; viscosity at 25° C.=2,750 mPa·s; Mn=4,500; 1,2-vinyl group content=28%)

The following components were used as component (B).

Component (b-1): a dimethylhydrogensiloxy-terminated dimethylpolysiloxane (content of silicon atom-bonded hydrogen atoms=0.15 mass %) Component (b-2): tetrakis(dimethylsilyl) silane (content of silicon atom-bonded hydrogen atoms=1.23 mass %) Component (b-3): a trimethylsiloxy-terminated dimethylsiloxane methylhydrogensiloxane copolymer (content of silicon atom-bonded hydrogen atoms=0.78 mass %)

The following components were used as component (C).

Component (c-1): a 1,3-divinyl-1,1,3,3-tetramethyl disiloxane solution of a Pt complex with 1,3-divinyl-1,1,3,3-tetramethyldisiloxane (content of Pt atom=5,000 ppm) Component (c-2): a hexadiene solution of a Pt complex with 1,3-divinyl-1,1,3,3-tetramethyldisiloxane (content of Pt atom=5,000 ppm)

The following components were used as component (D).

Component (d-1): alumina filler having an average particle size of 0.44 μm (trade name: AES-12, commercially available from SUMITOMO CHEMICAL COMPANY. LIMITED) Component (d-2): roundish shaped alumina filler having an average particle size of 35 μm (trade name: ACF-6, commercially available from Zhengzhou Research Institute of Chalco of China)
Component (d-3): hydroxy aluminum filler having an average particle size of 0.8-1.2 μm (trade name: KH-101, commercially available from KC Corporation)
Component (d-4): hydroxy aluminum filler having an average particle size of 25 μm (trade name: SH-25B3, commercially available from KC Corporation)

The following component was used as component (E).

Component (e-1): n-decyl trimethoxysilane

TABLE 1

| | | | Category | | | | | |
|---|---|---|---|---|---|---|---|---|
| | | | Practical Examples | | | | | |
| | | | IE-1 | | IE-2 | | IE-3 | |
| Item | | | Part A | Part B | Part A | Part B | Part A | Part B |
| Curable | (A) | (a-1) | 12.60 | 10.76 | 10.88 | 10.88 | 12.60 | 7.16 |
| Polyolefin | | (a-2) | 0 | 0 | 0 | 0 | 0 | 0 |
| Composition | (B) | (b-1) | 0 | 3.40 | 0 | 5.00 | 0 | 7.00 |
| (parts | | (b-2) | 0 | 0 | 0 | 0 | 0 | 0 |
| by mass) | | (b-3) | 0 | 0 | 0 | 0 | 0 | 0 |
| | (C) | (c-1) | 1.50 | 0 | 1.50 | 0 | 1.50 | 0 |
| | | (c-2) | 0 | 0 | 0 | 0 | 0 | 0 |
| | (D) | (d-1) | 26.50 | 26.50 | 26.50 | 26.50 | 26.50 | 26.50 |
| | | (d-2) | 59.00 | 59.00 | 59.00 | 59.00 | 59.00 | 59.00 |
| | | (d-3) | 0 | 0 | 0 | 0 | 0 | 0 |
| | | (d-4) | 0 | 0 | 0 | 0 | 0 | 0 |
| | (E) | (e-1) | 0.37 | 0.37 | 0.37 | 0.37 | 0.37 | 0.37 |
| Viscosity (Pa · s) | | | 116 | 152 | 209 | 125 | 109 | 190 |
| Total content of | | | 2.45 | | 3.25 | | 4.25 | |
| component (B) (mass %) | | | | | | | | |
| Total content of | | | 85.50 | | 85.50 | | 85.50 | |
| component (D) (mass %) | | | | | | | | |
| Content of Pt (ppm) | | | 37.50 | | 37.50 | | 37.50 | |
| Hardness | Shore OO | | 45 | | 55 | | 77 | |
| | Shore A | | <10 | | <10 | | <10 | |
| TC (W/mK) | | | 2 | | 2 | | 2 | |
| | | | Category | | | | | |
| | | | Practical Examples | | | | | |
| | | | IE-4 | | IE-5 | | IE-6 | |
| Item | | | Part A | Part B | Part A | Part B | Part A | Part B |
| Curable | (A) | (a-1) | 12.60 | 8.26 | 15.25 | 14.69 | 15.25 | 14.54 |
| Polyolefin | | (a-2) | 0 | 0 | 0 | 0 | 0 | 0 |
| Composition | (B) | (b-1) | 0 | 7.0 | 0 | 0 | 0 | 0 |
| (parts | | (b-2) | 0 | 0 | 0 | 1.15 | 0 | 1.3 |
| by mass) | | (b-3) | 0 | 0 | 0 | 0 | 0 | 0 |
| | (C) | (c-1) | 0.40 | 0 | 0.60 | 0 | 0.60 | 0 |
| | | (c-2) | 0 | 0 | 0 | 0 | 0 | 0 |
| | (D) | (d-1) | 26.50 | 26.50 | 0 | 0 | 0 | 0 |
| | | (d-2) | 59.00 | 59.00 | 0 | 0 | 0 | 0 |
| | | (d-3) | 0 | 0 | 25.50 | 25.50 | 25.50 | 25.50 |
| | | (d-4) | 0 | 0 | 58.30 | 58.30 | 58.30 | 58.30 |
| | (E) | (e-1) | 0.37 | 0.37 | 0.37 | 0.37 | 0.37 | 0.37 |
| Viscosity (Pa · s) | | | 116 | 197 | 239 | 208 | 257 | 200 |
| Total content of | | | 3.70 | | 0.87 | | 0.95 | |
| component (B) (mass %) | | | | | | | | |
| Total content of | | | 85.50 | | 83.79 | | 83.79 | |
| component (D) (mass %) | | | | | | | | |
| Content of Pt (ppm) | | | 10.00 | | 15.00 | | 15.00 | |
| Hardness | Shore OO | | 65 | | 40 | | 65 | |
| | Shore A | | <10 | | <10 | | <10 | |
| TC (W/mK) | | | 2 | | 2 | | 2 | |
| | | | Category | | | | | |
| | | | Practical Examples | | | | | |
| | | | IE-7 | | IE-8 | | IE-9 | |
| Item | | | Part A | Part B | Part A | Part B | Part A | Part B |
| Curable | (A) | (a-1) | 15.80 | 14.74 | 15.80 | 14.74 | 11.89 | 11.89 |
| Polyolefin | | (a-2) | 0 | 0 | 0 | 0 | 0 | 0 |
| Composition | (B) | (b-1) | 0 | 0 | 0 | 0 | 0 | 0 |
| (parts | | (b-2) | 0 | 1.15 | 0 | 1.15 | 0 | 0 |
| by mass) | | (b-3) | 0 | 0 | 0 | 0 | 0 | 2.99 |
| | (C) | (c-1) | 0 | 0 | 0 | 0 | 1.50 | 0 |
| | | (c-2) | 0.60 | 0 | 1.20 | 0 | 0 | 0 |
| | (D) | (d-1) | 0 | 0 | 0 | 0 | 26.50 | 26.50 |
| | | (d-2) | 0 | 0 | 0 | 0 | 59.00 | 59.00 |
| | | (d-3) | 25.50 | 25.50 | 25.50 | 25.50 | 0 | 0 |
| | | (d-4) | 58.30 | 58.30 | 58.30 | 58.30 | 0 | 0 |
| | (E) | (e-1) | 0.37 | 0.37 | 0.37 | 0.37 | 0.37 | 0.37 |
| Viscosity (Pa · s) | | | 134 | 205 | 160 | 228 | 147 | 164 |
| Total content of | | | 0.57 | | 0.57 | | 2.24 | |
| component (B) (mass %) | | | | | | | | |
| Total content of | | | 83.54 | | 83.29 | | 85.50 | |
| component (D) (mass %) | | | | | | | | |
| Content of Pt (ppm) | | | 14.95 | | 29.82 | | 37.50 | |
| Hardness | Shore OO | | 35 | | 40 | | 79 | |
| | Shore A | | <10 | | <10 | | 15 | |
| TC (W/mK) | | | 2 | | 2 | | 2 | |
| | | | Category | | | | | |
| | | | Comparative Examples | | | | | |
| | | | CE-1 | | CE-2 | | CE-3 | |
| Item | | | Part A | Part B | Part A | Part B | Part A | Part B |
| Curable | (A) | (a-1) | 12.60 | 8.26 | 13.45 | 11.61 | 13.38 | 3.38 |
| Polyolefin | | (a-2) | 0 | 0 | 0 | 0 | 0 | 0 |
| Composition | (B) | (b-1) | 0 | 7.00 | 0 | 1.70 | 0 | 10.00 |
| (parts | | (b-2) | 0 | 0 | 0 | 0 | 0 | 0 |
| by mass) | | (b-3) | 0 | 0 | 0 | 0 | 0 | 0 |
| | (C) | (c-1) | 0.06 | 0 | 1.50 | 0 | 1.50 | 0 |
| | | (c-2) | 0 | 0 | 0 | 0 | 0 | 0 |
| | (D) | (d-1) | 26.50 | 26.50 | 26.50 | 26.50 | 26.50 | 26.50 |
| | | (d-2) | 59.00 | 59.00 | 59.00 | 59.00 | 59.00 | 59.00 |
| | | (d-3) | 0 | 0 | 0 | 0 | 0 | 0 |
| | | (d-4) | 0 | 0 | 0 | 0 | 0 | 0 |
| | (E) | (e-1) | 0.37 | 0.37 | 0.37 | 0.37 | 0.37 | 0.37 |
| Viscosity (Pa · s) | | | 116 | 197 | 112 | 173 | 100 | 155 |
| Total content of | | | 3.54 | | 1.60 | | 5.75 | |
| component (B) (mass %) | | | | | | | | |
| Total content of | | | 85.65 | | 85.50 | | 85.50 | |
| component (D) (mass %) | | | | | | | | |
| Content of Pt (ppm) | | | 1.50 | | 37.50 | | 37.50 | |
| Hardness | Shore OO | | Uncured | | Uncured | | 80 | |
| | Shore A | | — | | — | | 25 | |
| TC (W/mK) | | | — | | — | | 2 | |
| | | | Category | | | | | |
| | | | Comparative Examples | | | | | |
| | | | CE-4 | | CE-5 | | CE-6 | |
| Item | | | Part A | Part B | Part A | Part B | Part A | Part B |
| Curable | (A) | (a-1) | 11.76 | 0 | 15.20 | 14.39 | 13.50 | 12.66 |
| Polyolefin | | (a-2) | 0 | 0 | 0 | 0 | 0 | 0 |
| Composition | (B) | (b-1) | 0 | 15.00 | 0 | 0 | 0 | 0 |
| (parts | | (b-2) | 0 | 0 | 0 | 1.50 | 0 | 1.50 |
| by mass) | | (b-3) | 0 | 0 | 0 | 0 | 0 | 0 |
| | (C) | (c-1) | 1.50 | 0 | 0.60 | 0 | 0.60 | 0 |
| | | (c-2) | 0 | 0 | 0 | 0 | 0 | 0 |
| | (D) | (d-1) | 26.50 | 26.50 | 0 | 0 | 26.50 | 26.50 |
| | | (d-2) | 59.00 | 59.00 | 0 | 0 | 59.00 | 59.00 |
| | | (d-3) | 0 | 0 | 25.50 | 25.50 | 0 | 0 |
| | | (d-4) | 0 | 0 | 58.30 | 58.30 | 0 | 0 |
| | (E) | (e-1) | 0.37 | 0.37 | 0.37 | 0.37 | 0.37 | 0.37 |

| Viscosity (Pa · s) | 163 | 28 | 187 | 202 | 129 | 146 |
|---|---|---|---|---|---|---|
| Total content of | 8.25 | | 1.05 | | 1.05 | |
| component (B) (mass %) | | | | | | |
| Total content of | 85.50 | | 83.79 | | 85.50 | |
| component (D) (mass %) | | | | | | |

| Content of Pt (ppm) | | 37.50 | 15.00 | 15.00 |
|---|---|---|---|---|
| Hardness | Shore OO | >85 | >85 | >85 |
| | Shore A | 85 | 55 | 50 |

| | | | |
|---|---|---|---|
| TC (W/mK) | 2 | 2 | 2 |

| | | | Category | | | |
|---|---|---|---|---|---|---|
| | | | Comparative Examples | | | |
| | | | CE-7 | | CE-8 | |
| Item | | | Part A | Part B | Part A | Part B |
| Curable | (A) | (a-1) | 10.69 | 10.69 | 0 | 0 |
| Polyolefin | | (a-2) | 0 | 0 | 11.89 | 11.89 |
| Composition | (B) | (b-1) | 0 | 0 | 0 | 0 |
| (parts | | (b-2) | 0 | 0 | 0 | 0 |
| by mass) | | (b-3) | 0 | 5.37 | 0 | 2.99 |
| | (C) | (c-1) | 1.50 | 0 | 1.50 | 0 |
| | | (c-2) | 0 | 0 | 0 | 0 |
| | (D) | (d-1) | 26.50 | 26.50 | 26.50 | 26.50 |
| | | (d-2) | 59.00 | 59.00 | 59.00 | 59.00 |
| | | (d-3) | 0 | 0 | 0 | 0 |
| | | (d-4) | 0 | 0 | 0 | 0 |
| | (E) | (e-1) | 0.37 | 0.37 | 0.37 | 0.37 |

| Viscosity (Pa · s) | 187 | 103 | 378 | 514 |
|---|---|---|---|---|
| Total content of | 3.44 | | 2.24 | |
| component (B) (mass %) | | | | |
| Total content of | 85.50 | | 85.50 | |
| component (D) (mass %) | | | | |

| Content of Pt (ppm) | | 37.50 | 37.50 |
|---|---|---|---|
| Hardness | Shore OO | >85 | >85 |
| | Shore A | 85 | 70 |

| | | |
|---|---|---|
| TC (W/mK) | 2 | 2 |

As shown in Table 1, the compositions of IE-1 to IE-9 were cured to form soft materials having a Shore OO hardness of less than 80 and with good thermal conductive property. In contrast to the compositions of IE-1 to IE-4, the comparative compositions of CE-1 and CE-2 was not cured because of lacking component (C) and lacking component (B).

As shown in Table 1, in contrast to the compositions of IE-1 to IE-4, the comparative compositions of CE-3 and CE-4 could not form soft materials because of over loading component (B). In the same way, in contrast to the compositions of IE-5 to IE-8, the comparative composition of CE-5 could not form a soft material because of over loading component (B). And in the same way, in contrast to the compositions of IE-1 to IE-4 and IE-9, the comparative compositions of CE-6 and CE-7 could not form soft materials because of over loading component (B).

As shown in Table 1, in contrast to the composition of IE-9, the comparative composition of CE-8 could not form a soft material because the polyolefin for component (A) had a viscosity at 25° C. of 2,500 Pa·s or more. While, in the comparative composition of CE-8, each viscosities of Part A and Part B was higher than 300 Pa·s.

### INDUSTRIAL APPLICABILITY

The curable polyolefin composition of the present invention can be cured to form a soft material with good thermal conductive properties. Therefore, the curable polyolefin composition is useful for a thermal management material of batteries in electric vehicles.

1. A curable polyolefin composition comprising:
(A) a polyolefin having at least two aliphatic unsaturated bonds per molecule and having a viscosity at 25° C. of less than 2,500 mPa·s;
(B) an organopolysiloxane having at least two silicon atom-bonded hydrogen atoms per molecule, in an amount such that a cured product obtained by curing the composition has a Shore OO hardness of less than 80;
(C) a hydrosilylation reaction catalyst, in an amount such that a catalytic metal in this component relative to the composition is not less than 2 ppm in terms of mass unit; and
(D) a thermal conductive filler.

2. The curable polyolefin composition according to claim 1, wherein component (A) is a polybutadiene.

3. The curable polyolefin composition according to claim 1, wherein component (D) is a thermal conductive filler selected from metals, alloys, nonmetals, metal oxides, metal hydroxides or ceramics.

4. The curable polyolefin composition according to claim 1, wherein a content of component (D) is not less than 50 mass % of the composition.

5. The curable polyolefin composition according to claim 1, further comprising: (E) a filler treating agent.

6. The curable polyolefin composition according to claim 5, wherein a content of component (E) is not more than 1 mass % of the composition.

7. A cured product obtained by curing the curable polyolefin composition described in claim 1, wherein the cured product has a Shore OO hardness of less than 80.

8. The cured product according to claim 7, which is disposed between a battery and a heat sink in an electric vehicle.
